(19) United States
(12) Patent Application Publication
(10) Pub. No.: US 2008/0319594 A1
(43) Pub. Date: Dec. 25, 2008

(54) Control Apparatus for Hybrid Vehicle

(76) Inventors: Tomohiro Shibata, Shioya-gun (JP); Shinichi Kitajima, Utsunomiya-shi (JP); Takahiro Sasaki, Utsunomiya-shi (JP); Yasuo Nakamoto, Utsunomiya-shi (JP)

Correspondence Address: ARENT FOX LLP, 1050 CONNECTICUT AVENUE, N.W., SUITE 400, WASHINGTON, DC, 20036, US

(21) Appl. No.: 11/632,908

(22) PCT Filed: Jul. 22, 2005
(86) PCT No.: PCT/JP2005/013499

§ 371 Date: Jan. 19, 2007

(30) Foreign Application Priority Data
Jul. 23, 2004 (JP) 2004-215431

(51) Int. Cl. B60L 15/00; G06F 19/00

(52) U.S. Cl. 701/22; 701/93; 903/940

(57) ABSTRACT

A control apparatus for a hybrid vehicle that includes an engine and an electric motor as driving sources for the vehicle, and an energy storage device that stores an output of the engine or a kinetic energy of the vehicle after being converted into electric energy by the electric motor. The engine is a cylinder deactivation engine that is capable of deactivating. The control apparatus includes an electric motor-only travel determination device that determines whether a motor-only travel, in which the engine is deactivated and only the motor is used for driving the vehicle, is allowed based on at least vehicle speed, an initial state of charge calculating device that calculates an initial state of charge of the energy storage device when an ignition of the vehicle is turned on, a running interval state of charge calculating device that calculates an amount of change between a state of charge of the energy storage device at each time the vehicle stops, and an upper limit vehicle speed correcting device that corrects an upper limit vehicle speed during an electric motor-only travel that is allowed by the electric motor-only travel determination device based on a difference between the initial state of charge calculated by the initial state of charge calculating device and the running interval state of charge calculated by the running interval state of charge calculating device.

### TECHNICAL FIELD

The present invention relates to a control apparatus for a hybrid vehicle that includes an engine and an electric motor and that can be driven using the driving power of the electric motor alone or the driving power of the engine.

Priority is claimed on Japanese Patent Applications No. 2004-215431, filed Jul. 23, 2004, the content of which is incorporated herein by reference.

### BACKGROUND ART

Conventionally, hybrid vehicles are known that include an engine and an electric motor as driving power sources and travel by the driving power of at least one of the engine or the electric motor being transmitted to the drive wheels. According to such a hybrid vehicle, the amount of fuel consumption and the amount of exhaust gas are reduced by making appropriate use of the engine and the electric motor depending on the operating conditions.

There are hybrid vehicles of this type that realize improvements in fuel economy by regenerating the deceleration energy using one or more of the electric motors that are provided in the vehicle, and using this regenerated energy as energy during reacceleration. Furthermore, there are hybrid vehicles that realize further improvements in fuel economy by using the regenerated energy during electric motor-only travel.

For example, technology is proposed in Patent Document 1, that realizes improvements in fuel economy by rationalizing the driving status of the vehicle in line with the intentions of the driver by adjusting the amount that the battery is charged by the electric motor depending on the throttle opening degree.
Patent Document 1: Japanese Unexamined Patent Application, First Publication No. 2001-128310

### DISCLOSURE OF THE INVENTION

### Problems to be Solved by the Invention

However, in the case in which sufficient electric power has accumulated in an electrical energy storage device, traveling with only the driving power of the electric motor (EV travel) is preferable in terms of improving fuel economy. On the other hand, when travel continues using the driving power of the electric motor, the electric power in the storage device decreases by an equivalent amount, and in order to ensure the driving performance, it is necessary to ensure in advance that the electric power accumulated in the storage device is equal to or greater than a predetermined amount.

In contrast, during cruise mode travel or the like in which load of travel is small, when all the cylinders of the engine are deactivated and the vehicle travels only using the driving power of the electric motor (EV cruise mode travel), there are the advantages that cruise mode travel is possible in a state in which the friction torque of the engine is restrained, and furthermore, regenerated energy can be accumulated in the energy storage device during subsequent decelerating travel.

However, in the case in which a large amount of the electric power in the energy storage device is consumed due to the EV cruise mode travel and sufficient energy cannot be recovered even by subsequent regenerative operations, when the cruise mode travel continues further, there are the problems in that the electric power in the energy storage device is greatly decreased and the driving performance is degraded.

Thus, an object of the present invention is to provide a control apparatus for a hybrid vehicle that can improve fuel economy while ensuring driving performance.

### Means for Solving the Problem

In order to solve the above problem, the present invention provides a control apparatus for a hybrid vehicle that includes an engine (e.g., an engine E in an embodiment) and an electric motor as driving sources for the vehicle, and an energy storage device (e.g., a battery 3 in an embodiment) that stores an output of the engine or a kinetic energy of the vehicle after being converted into electric energy by the electric motor, the engine being a cylinder deactivation engine that is capable of deactivating, the control apparatus including: an electric motor-only travel determination device (e.g., a determination in FIG. 5 in an embodiment) that determines whether a motor-only travel, in which the engine is deactivated and only the motor is used for driving the vehicle, is allowed based on at least vehicle speed; an initial state of charge calculating device (e.g., a battery CPU 1B in an embodiment) that calculates an initial state of charge (e.g., an initial state of charge SOCINT in an embodiment) of the energy storage device when an ignition of the vehicle is turned on; a running interval state of charge calculating device (e.g., a battery CPU 1B in an embodiment) that calculates an amount of change between a state of charge of the energy storage device at each time the vehicle stops; and an upper limit vehicle speed correcting device (e.g., step S56 in an embodiment)that corrects an upper limit vehicle speed during an electric motor-only travel that is allowed by the electric motor-only travel determination device based on a difference (e.g., an EV cruise execution upper limit vehicle speed #VEVCRSH in an embodiment) between the initial state of charge calculated by the initial state of charge calculating device and the running interval state of charge (e.g., a running interval state of charge SOCSTOP1 in an embodiment) calculated by the running interval state of charge calculating device.

According to the invention described above, the initial state of charge calculated by the initial state of charge calculating device and the running interval state of charge calculated by the running interval state of charge calculating device are compared, and the upper limit vehicle speed of electric motor-only travel is corrected by the upper limit vehicle speed correcting device, it is possible to carry out suitable electric motor-only travel under conditions in which the state of charge of the energy storage device is ensured to be equal to or greater than a predetermined amount. More specifically, when the running interval state of charge is greater than the initial state of charge, by correcting the upper limit vehicle speed so as to become higher and enabling electric motor-only travel at a higher speed, it is possible to improve the fuel economy. In contrast, when the running interval state of charge is less than the initial state of charge, by correcting the upper limit vehicle speed so as to become lower and enabling electric motor-only travel only at a lower speed, it is possible to ensure that the state of charge of the energy storage device is equal to or greater than a predetermined amount. In this manner, it is possible to improve the fuel economy while ensuring driving performance by correcting the upper limit vehicle speed based on the state of the energy storage device.

More specifically, in the case in which a regenerative operation is carried out frequently (for example, when travel down a slope is frequent) and the difference between the initial state of charge and the running interval state of charge is within a predetermined range and thereby a charge cycle is identified, the upper limit vehicle speed is corrected so as to become high, and in the case in which the difference between the initial state of charge and the running interval state of charge is equal to or greater than a predetermined range and thereby a discharge cycle is identified, the upper limit vehicle speed is corrected so as to become low; therefore, it is possible to further improve the fuel economy while maintaining the driving performance.

The control apparatus for a hybrid vehicle described above may further include an electric motor upper limit output correcting device (e.g., step S68 and step S70 in an embodiment) that corrects an upper limit output power of the electric motor (e.g., a cruise EV permission output power EVPWR in an embodiment) during the electric motor-only travel that is allowed by the electric motor-only travel determination device based on the difference between the initial state of charge calculated by the initial state of charge calculating device and the running interval state of charge calculated by the running interval state of charge calculating device.

According to the invention described above, by correcting the upper limit output of electric motor-only travel, the electric power necessary for the output of the electric motor can be set to a power that is appropriate for the state of charge of the energy storage device, and thereby it is possible to further improve the driving performance.

The control apparatus for a hybrid vehicle described above may further include: an interval state of charge difference calculating device (e.g., a battery CPU 1B in an embodiment) that calculates an amount of change (e.g., an interval state of charge difference DODVS in an embodiment) from the state of charge of the energy storage device at a previous vehicle stop (e.g., a running interval state of charge SOCSTOP1 in an embodiment) to the state of charge of the energy storage device at a present vehicle stop (e.g., a running interval state of charge SOCSTOP2 in an embodiment); and an upper limit vehicle speed correcting device that corrects an upper limit vehicle speed during an electric motor-only travel that is allowed by the electric motor-only travel determination device based on the amount of change in the state of charge calculated by the interval state of charge difference calculating device.

According to the invention described above, the upper limit vehicle speed can be more precisely corrected depending on the interval state of charge difference that is the amount of change in the state of charge of the energy storage device calculated in every interval. More specifically, when the interval state of charge difference is large (for example, in a decreasing trend), this means that the state of charge has rapidly decreased in this interval; therefore, by taking the amount of decrease in the interval into consideration and correcting the upper limit vehicle speed during the electric motor-only travel by an amount corresponding to the amount of decrease, it is possible to more precisely set the upper limit vehicle speed, and thus it is possible to further improve the fuel economy by restraining the upper limit vehicle speed while maintaining the driving performance.

The control apparatus for a hybrid vehicle described above may further include an upper limit output power correcting device that corrects an upper limit output power during an electric motor-only travel that is allowed by the electric motor-only travel determination device based on the amount of change in the state of charge calculated by the interval state of charge difference calculating device.

According to the invention described above, the upper limit output power can be more precisely corrected depending on the interval state of charge difference that is the amount of change in the state of charge of the energy storage device calculated in every interval. More specifically, when the interval state of charge difference is large (for example, in a decreasing trend), this means that the state of charge has rapidly decreased in this interval; therefore, by taking the amount of decrease in the interval into consideration and correcting the upper limit output power during the electric motor-only travel by an amount corresponding to the amount of decrease, it is possible to more precisely set the upper limit output power, and thus it is possible to further improve the fuel economy by restraining the upper limit output power while maintaining the driving performance.

The present invention further provides a control apparatus for a hybrid vehicle that includes an engine and an electric motor as driving sources for the vehicle, and an energy storage device that stores an output of the engine or a kinetic energy of the vehicle after being converted into electric energy by the electric motor, the engine being a cylinder deactivation engine that is capable of deactivating, the control apparatus including: an electric motor-only travel determination device that determines whether a motor-only travel, in which the engine is deactivated and only the motor is used for driving the vehicle, is allowed based on at least vehicle speed; an interval state of charge difference calculating device that calculates an amount of change from the state of charge of the energy storage device at a previous vehicle stop to the state of charge of the energy storage device at a present vehicle stop; and an upper limit vehicle speed correcting device that corrects an upper limit vehicle speed during an electric motor-only travel that is allowed by the electric motor-only travel determination device based on the amount of change in the state of charge calculated by the interval state of charge difference calculating device.

According to the invention described above, the upper limit vehicle speed can be more precisely corrected depending on the interval state of charge difference that is the amount of change in the state of charge of the energy storage device calculated in every interval. More specifically, when the interval state of charge difference is large (for example, in a decreasing trend), this means that the state of charge has rapidly decreased in this interval; therefore, by taking the amount of decrease in the interval into consideration and correcting the upper limit vehicle speed during the electric motor-only travel by an amount corresponding to the amount of decrease, it is possible to more precisely set the upper limit vehicle speed, and thus it is possible to further improve the fuel economy by restraining the upper limit vehicle speed while maintaining the driving performance.

The control apparatus for a hybrid vehicle described above may further include an upper limit output power correcting device that corrects an upper limit output power during an electric motor-only travel that is allowed by the electric motor-only travel determination device based on the amount of change in the state of charge calculated by the interval state of charge difference calculating device.

According to the invention described above, the upper limit output power can be more precisely corrected depending on the interval state of charge difference that is the amount of change in the state of charge of the energy storage device calculated in every interval. More specifically, when the interval state of charge difference is large (for example, in a decreasing trend), this means that the state of charge has rapidly decreased in this interval; therefore, by taking the amount of decrease in the interval into consideration and correcting the upper limit output power during the electric motor-only travel by an amount corresponding to the amount of decrease, it is possible to more precisely set the upper limit output power, and thus it is possible to further improve the fuel economy by restraining the upper limit output power while maintaining the driving performance.

According to the present invention, it is possible to improve the fuel economy by restraining the upper limit vehicle speed while ensuring the driving performance.

Moreover, according to the present invention, it is possible to improve the fuel economy by restraining the upper limit vehicle speed and restraining the upper limit output power of the electric motor while ensuring the driving performance.

Moreover, according to the present invention, by taking the amount of decrease in the state of charge in the interval into consideration and correcting the upper limit vehicle speed during the electric motor-only travel by an amount corresponding to the amount of decrease, it is possible to more precisely set the upper limit vehicle speed, and thus it is possible to further improve the fuel economy by restraining the upper limit vehicle speed while maintaining the driving performance.

Moreover, according to the present invention, by taking the amount of decrease in the state of charge in the interval into consideration and correcting the upper limit output power during the electric motor-only travel by an amount corresponding to the amount of decrease, it is possible to more precisely set the upper limit output power, and thus it is possible to further improve the fuel economy by restraining the upper limit output power while maintaining the driving performance.

### BRIEF DESCRIPTION OF THE DRAWINGS

FIG. 1 is a general structural view showing a hybrid vehicle in an embodiment of the present invention.

FIG. 2 is a front view showing a variable valve timing mechanism in the embodiment of the present invention.

FIG. 3A is a cross-sectional view showing the essential components of the variable valve timing mechanism in an all-cylinder activated mode.

FIG. 3B is a cross-sectional view showing the essential components of the variable timing mechanism in an all-cylinder deactivated mode.

FIG. 4 is an enlarged explanatory view showing the variable valve timing mechanism VT and an oil pressure control device provided in the hybrid vehicle shown in FIG. 1.

FIG. 5 is a block diagram showing each of the operation modes of an electric motor provided in the hybrid vehicle shown in FIG. 1.

FIG. 6 is a flowchart showing the content of the operation for the cylinder deactivation permission determination of the engine.

FIG. 7 is a flowchart showing the content of the operation for the cylinder deactivation permission determination of the engine.

FIG. 8 is a flowchart showing the content of the operation for the EV request determination during cruise travel.

FIG. 9 is a flowchart showing the content of the operation for the EV request determination during cruise travel.

FIG. 10 is a flowchart showing the content of the operation for the EV request determination during cruise travel.

FIG. 11 is a graph showing the relationship between the depth of discharge running interval limit value DODV and the EV cruise travel determination vehicle speed VEVCRSH.

FIG. 12 is a graph showing the relationship between the depth of discharge running interval limit value DODV and the output correction coefficient KDODVEVP.

FIG. 13 is a graph showing the relationship between the vehicle speed and the state of charge of the battery that change with time elapsing.

### DESCRIPTION OF THE REFERENCE SYMBOLS

1B: battery CPU (initial state of charge calculating device, running interval state of charge calculating device, interval state of charge difference calculating device)
E: engine
M: motor
IV: intake valve
EV: exhaust valve
VT: variable valve timing mechanism
SOCINT: initial state of charge
SOCSTOP1: interval state of charge at time STOP1
SOCSTOP2: interval state of charge at time STOP2 DODV: depth of discharge running interval limit value (a difference between interval state of charges)
DODVS: interval state of charge difference (an amount of change)
EVPWR: cruise EV permission output power (upper limit output power)
#VEVCRSH: EV cruise execution upper limit vehicle speed (upper limit vehicle speed)
step S56: upper limit vehicle speed correcting device
steps S68 and S70: upper limit output power correcting device

### BEST MODE FOR CARRYING OUT THE INVENTION

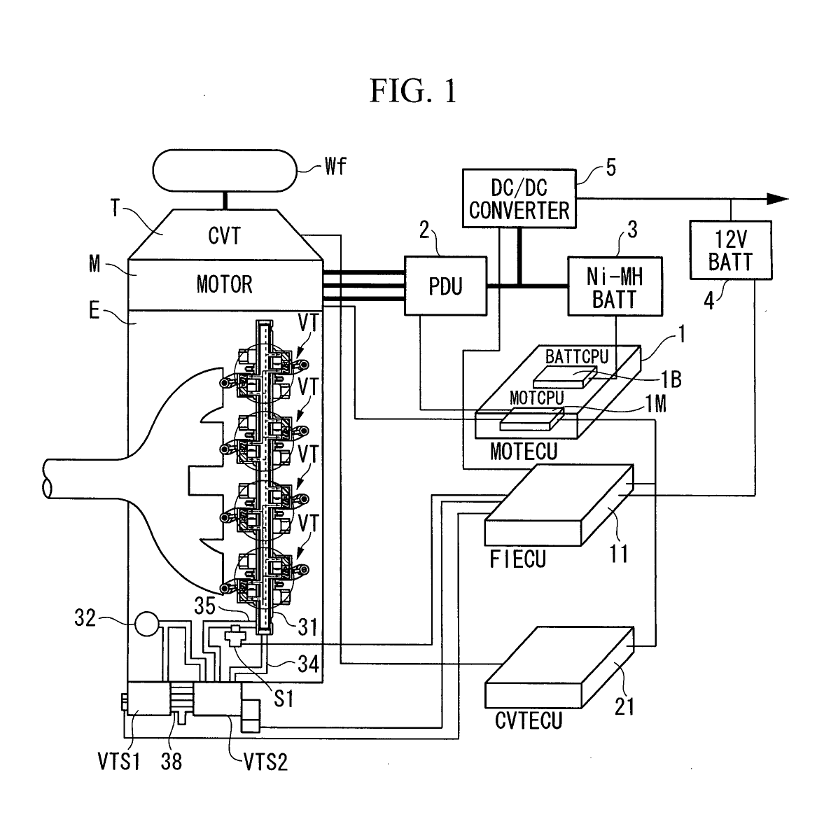

Below, the control apparatus for the hybrid vehicle in an embodiment of the present invention will be explained with reference to the appended drawings. FIG. 1 is a block diagram showing the hybrid vehicle of present embodiment. As shown in the figure, the hybrid vehicle includes an engine E, an electric motor (MOTOR) M, and a transmission (CVT) T, which are coupled to each other in series. The driving power generated by at least one of the engine E and the electric motor M is transmitted via, for example, a transmission T (the transmission T may be a manual transmission), such as a CVT to the output power axle to drive the front wheels Wf, which serve as the driving wheels. When the driving power is transmitted from the driving wheels Wf to the electric motor M during deceleration of the hybrid vehicle, the electric motor M acts as a generator to generate a regenerative braking force, and thereby the kinetic energy of the vehicle is recovered as electrical energy.

The driving of the electric motor M and the regenerating operation for the electric motor M are controlled by a power drive unit (PDU) 2 according to control commands from an electric motor CPU (MOTCPU) 1M of an electric motor ECU (MOTECU) 1. A high-voltage nickel metal hydride battery (Ni-MHBATT) 3 (energy storage device) for sending electrical energy to and receiving electrical energy from the electric motor M is connected to the power drive unit 2. The battery 3 includes a plurality of modules connected in series, and in each module, a plurality of cell units are connected in series. The hybrid vehicle includes a 12-volt auxiliary battery (12VBATT) 4 for energizing various electrical accessories. The auxiliary battery 4 is connected to the battery 3 via a downverter 5 as a DC-DC converter. The downverter 5, which is controlled by an FIECU 11, makes the voltage from the battery 3 step-down and charges the auxiliary battery 4. Note that the electric motor ECU 1 includes a battery CPU (BATTCPU) 1B (initial state of charge calculating device, running interval state of charge calculating device, interval state of charge difference calculating device) for protecting the battery 3 and calculating the state of charge of the battery 3, and a CVTECU 21 is connected to the transmission T, which is a CVT, for controlling the same.

The FIECU 11 controls, in addition to the electric motor ECU 1 and the downverter 5, a fuel injection valve (not shown) for controlling the amount of fuel supplied to the engine E, a starter motor, ignition timing, and the like. To this end, the FIECU 11 receives various signals such as a signal from a vehicle speed sensor, a signal from an engine revolution rate sensor, a signal from a shift position sensor, a signal from a brake switch, a signal from a clutch switch, a signal from a throttle opening-degree sensor, and a signal from an intake negative pressure sensor (none shown). In addition, the FIECU 11 also receives a signal from a POIL sensor S1, which detects the oil pressure of the hydraulic fluid supplied to the cylinder activation passage 35, and signals from the solenoids of spool valves VTS1 and VTS2, which will be further explained later.

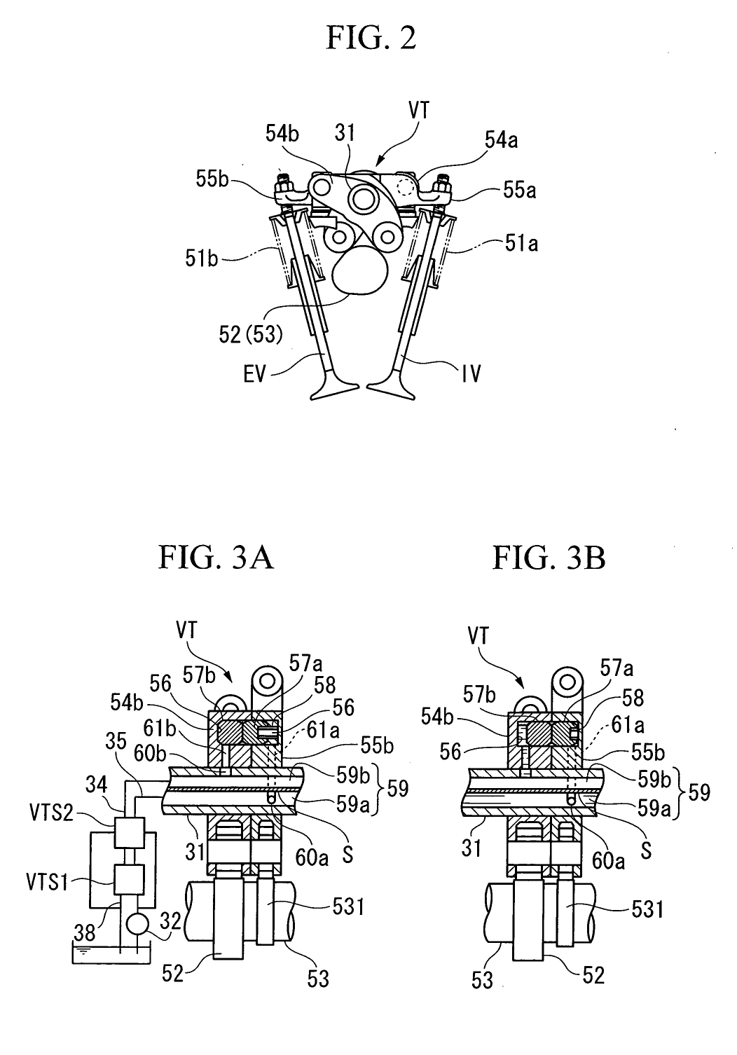

Next, the variable valve timing mechanism VT and hydraulic control devices will be explained in detail with reference to FIGS. 2 to 4. Note that the structure of the hydraulic control devices associated with each of the rocker shafts are both identical, and thus the rocker shaft 31 side will be explained as an example.

As shown in FIG. 2, the cylinder (not shown) is provided with an intake valve and an exhaust valve which are biased by valve springs 51a and 51b in a direction which closes an intake port (not shown) and an exhaust port (not shown), respectively. Reference symbol 52 indicates a lift cam provided on a camshaft 53. The lift cam 52 is engaged with an intake cam lifting rocker arm 54a for lifting the intake valve and an exhaust cam lifting rocker arm 54b for lifting the exhaust valve, both of which are rockably supported by the rocker shaft 31.

The rocker shaft 31 also supports valve operating rocker arms 55a and 55b in a rockable manner, which are located adjacent to the cam lifting rocker arms 54a and 54b, and whose rocking ends press the top ends of the intake valve IV and the exhaust valve EV, respectively, so that the intake valve IV and the exhaust valve EV open their respective ports. As shown in FIGS. 3A and 3B, the proximal ends (opposite the ends contacting the valves) of the valve operating rocker arms 55a and 55b are adapted to engage a circular cam 531 provided on the camshaft 53 so as to be able to slide.

Using the exhaust valve EV side as an example, FIG. 3 shows the cam lifting rocker arm 54b and the valve operating rocker arm 55b.

As shown in FIGS. 3A and 3B, a hydraulic chamber 56 is located on the side opposite to the lift cam 52, where the rocker shaft 31 is the center, and is formed in the cam lifting rocker arm 54b and the valve operating rocker arm 55b in a continuous manner. The hydraulic chamber 56 is provided with a pin 57a and a disengaging pin 57b, both of which are made freely slidable and are biased toward the cam lifting rocker arm 54b by means of a pin spring 58.

Inside the rocker shaft 31, hydraulic passage 59 (59a and 59b) is divided by a partition S. The hydraulic passage 59b is connected to the hydraulic chamber 56 at the position where the disengaging pin 57b is located via an opening 60b of the hydraulic passage 59b and a communication port 61b in the cam lifting rocker arm 54b. The hydraulic passage 59a is connected to the hydraulic chamber 56 at the position where the pin 57a is located via an opening 60a of the hydraulic passage 59a and a communication port 61a in the valve operating rocker arm 55b, and is further connectable to a drain passage 38.

As shown in FIG. 3A, the pin 57a is positioned so as to bridge the cam lifting rocker arm 54b and the valve operating rocker arm 55b by the pin spring 58 when oil pressure is not applied via the hydraulic passage 59b. On the other hand, as shown in FIG. 3B, when oil pressure is applied via the hydraulic passage 59b in accordance with a cylinder deactivation signal, both of the pin 57a and the disengaging pin 57b slide toward the valve operating rocker arm 55b against the biasing force of the pin spring 58, and the interface between the pin 57a and the disengaging pin 57b aligns with the interface between the cam lifting rocker arm 54b and the valve operating rocker arm 55b so as to disconnect these rocker arms 54b and 55b. The intake valve side is constructed in a similar manner. The hydraulic passages 59a and 59b are connected to an oil pump 32 via the spool valves VTS1 and VTS2, which are provided for ensuring oil pressure of the variable valve timing mechanisms VT.

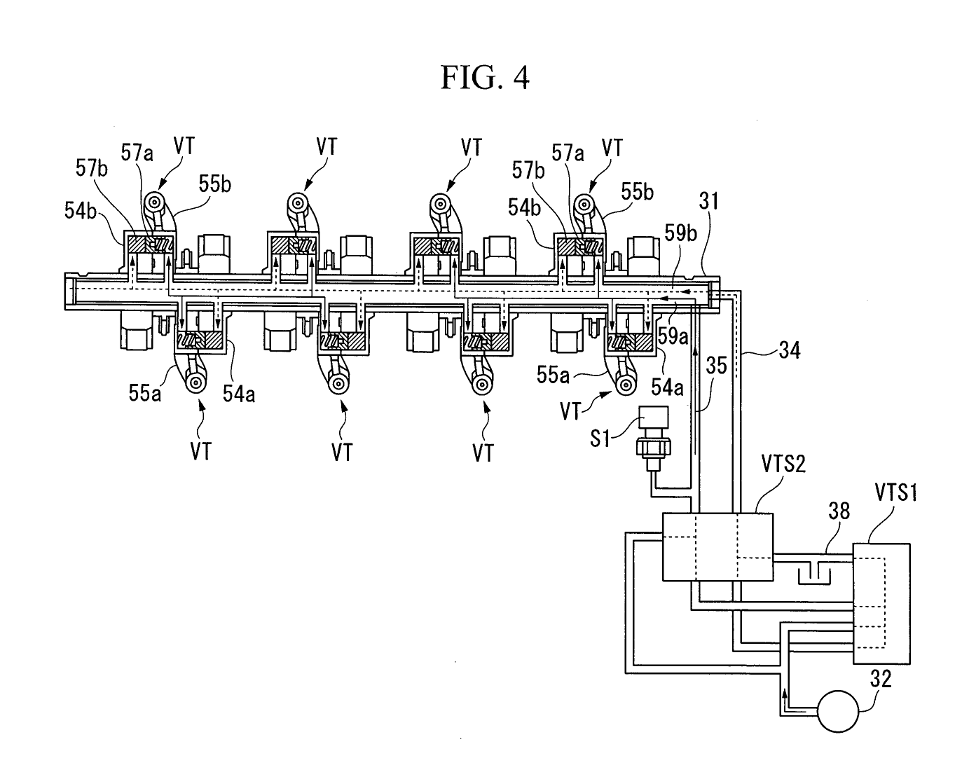

As shown in FIG. 4, a cylinder deactivation passage 34 is connected to the hydraulic passage 59b in the rocker shaft 31, and a cylinder activation passage 35 is connected to the hydraulic passage 59a.

The spool valve VTS2, which is provided as a cylinder activation enforcing device, is disposed between the spool valve VTS1, which is provided as a lift amount changing device, and the variable valve timing mechanisms VT, which are provided as a lift operating device. Continuous cylinder activation is executed by operating the spool valve VTS2.

The above-mentioned variable valve timing mechanisms VT and oil pressure control device are operated when a cylinder deactivation operation is executed during a cruise EV mode to be described below in which the electric motor M as a driving electric motor is solely used. The cylinder deactivation operation is executed in order to reduce mechanical loss (pumping loss) by closing both of the intake and exhaust valves of the engine E so that the engine E connected to the electric motor M does not apply load to the electric motor M.

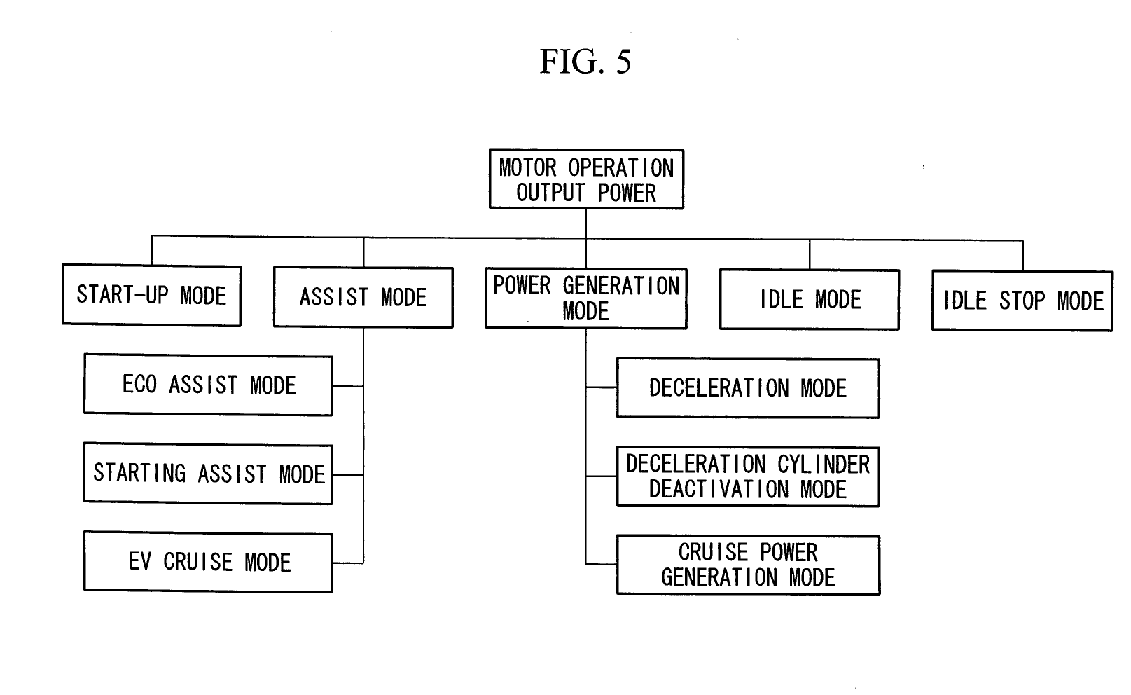

The operation modes of the electric motor M will be explained with reference to FIG. 5. FIG. 5 is a block diagram showing each of the operation modes of the electric motor M provided in the hybrid vehicle shown in FIG. 1. As shown in this figure, the electric motor M operates in a start-up mode, an assist mode, a power generation mode, an idle mode for the idle state, and an idle stop mode, one of which is selected (by an electric motor-only travel determination device) depending on predetermined conditions. The start-up mode is the mode during IG-ON. The assist mode is the mode in which the output of the engine E is assisted by the electric motor M. The power generation mode is the mode in which the kinetic energy is converted to electrical energy by a regenerative operation. The idle mode is the mode in which the fuel supply is restarted following a fuel cut and the engine E is maintained in the idle state. The idle stop mode is the mode in which the engine is stopped under certain conditions, such as when the vehicle is stopped.

Furthermore, the idle mode further includes an ECO assist mode, a starting assist mode, and a cruise EV mode. The cruise EV mode is the mode in which all cylinders in the engine E are deactivated and cruise travel is carried out with only the electric motor M by activating the electric motor to serve as an electric power generator.

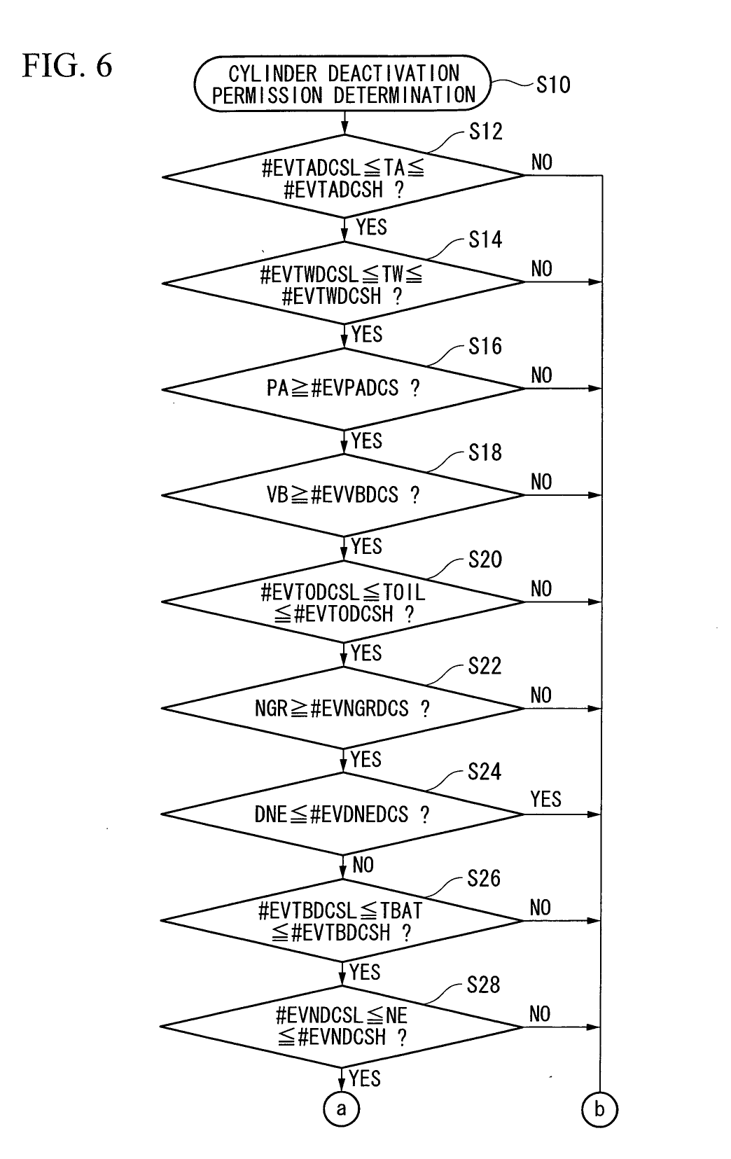

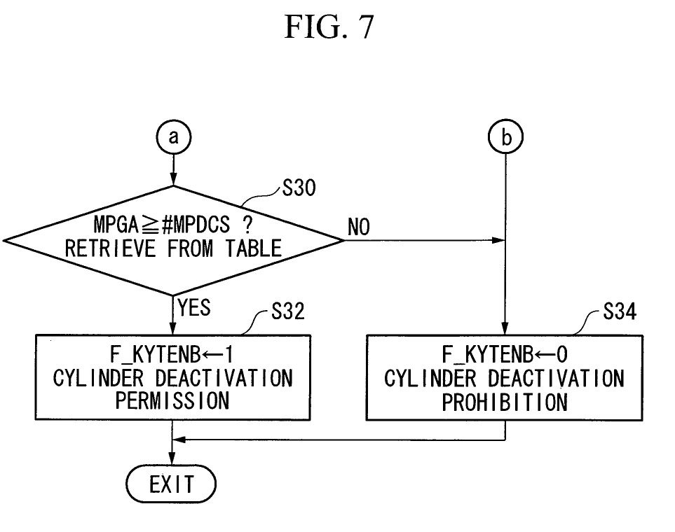

FIG. 6 and FIG. 7 are flowcharts showing the content of the operation for determining the cylinder deactivation permission for the engine. Note that this operation is repeated at a predetermined cycle. As shown in these figures, first, in step S10, the operation for determining the cylinder deactivation permission for the engine E is started.

Next, in step S12, it is determined whether or not the external air temperature TA is within a range equal to or greater than the cylinder deactivation execution lower limit external air temperature #EVTADCSL and equal to or less than the cylinder deactivation execution upper limit external air temperature #EVTADCSH. When the result of the determination is YES, the operation proceeds to step S14, and when the result of the determination is NO, the operation proceeds to step S34. In step S34, the cylinder deactivation permission flag F_KYTENB is set to 0, and the operation for prohibiting cylinder deactivation (all-cylinder deactivation operation) is carried out. The reason for providing this determination is that when the external air temperature TA falls below the cylinder deactivation execution lower limit external air temperature #TADCSL or rises above the cylinder deactivation execution upper limit external air temperature #TADCSH, the engine E becomes unstable when cylinder activation is carried out. After the operation in step S34 has been carried out, the operation for the present flowchart terminates.

In step S14, it is determined whether or not the engine coolant water temperature TW is within a range equal to or greater than the cylinder deactivation lower limit coolant water temperature #EVTWDCSL and equal to or less than the cylinder deactivation upper limit coolant water temperature #EVTWDSCH. If the result of the determination is YES, the operation proceeds to step S16, and if the result of the determination is NO, the operation proceeds to step S34 and cylinder deactivation is prohibited. The reason for providing this determination is that when the coolant water temperature TW falls below the cylinder deactivation execution lower limit coolant water temperature #TWDCSL or rises above the cylinder deactivation execution upper limit coolant water temperature #TWDCSH, the engine E will become unstable when cylinder activation is carried out.

In step S16, it is determined whether or not the atmospheric pressure PA is equal to or greater than the cylinder deactivation lower limit atmospheric pressure #EVPADCS. When the result of the determination is YES, the operation proceeds to step S18, and when the result of the determination is NO, the operation proceeds to step S34 and cylinder deactivation is prohibited. The reason for providing this determination is that when the atmospheric pressure is low, it is not preferable to carry out cylinder deactivation (for example, because there is the possibility that the negative pressure in the master power of the brake cannot be ensured to be sufficient during the braking operation).

In step S18, it is determined whether or not the voltage VB of the 12 volt auxiliary battery 4 is equal to or greater than the cylinder deactivation lower limit voltage #EVVBDCS. When the result of the determination is YES, the operation proceeds to step S20, and when the result of the determination is NO, the operation proceeds to step S34 and cylinder deactivation is prohibited. The reason for providing this determination is that when the voltage VB of the 12 volt auxiliary battery 4 is less than a predetermined value, the responsiveness of the spool valves VTS1 and VTS2 degrades. In addition, this is a countermeasure when the battery voltage becomes low due to a low temperature environment or when the battery deteriorates.

In step S20, it is determined whether or not the oil temperature (engine oil temperature) TOIL is within a range equal to or greater than the cylinder deactivation lower limit oil temperature #EVTODCSL and equal to or less than the cylinder deactivation upper limit oil temperature #EVTODSCH. When the result of the determination is YES, the operation proceeds to step S22, and when the result of the determination is NO, the operation proceeds to step S34 and cylinder deactivation is prohibited. The reason for providing this determination is that when the oil temperature TOIL falls below the cylinder deactivation lower limit oil temperature #EVTODCSL or rises above the cylinder deactivation upper limit oil temperature #EVTODCSH, the responsiveness of switching when the engine is running or when the cylinders are deactivated is not stable when cylinder deactivation is carried out.

In step S22, it is determined whether or not the gear position NGR is equal to or greater than the cylinder deactivation lower limit gear position #EVNGRDCS. When the result of the determination is YES (High gear), the operation proceeds to step S24, and when the result of the determination is NO (Low gear), the operation proceeds to step S34 and cylinder deactivation is prohibited. This is done in order to prevent lowering of the regeneration rate and frequent switching to cylinder deactivation at low gear, for example, during heavy traffic.

In addition, in conjunction with the determination of step S22, it is determined whether or not the clutch is in a half-clutch state. When the result of the determination is NO, the operation proceeds to step S34 and cylinder deactivation is prohibited. Thus, for example, it is possible to prevent engine stall during half-clutch due to stopping the vehicle and unnecessary cylinder deactivations in which malfunctions occur. An example of such a malfunction is being unable to respond to an acceleration request by the driver when the transmission shifts to the half-clutch state due to a gear change during acceleration.

Note that in the present embodiment, the transmission of the hybrid vehicle was explained for the case of a CVT (continuously variable transmission), but in the case in which the transmission of the hybrid vehicle is an AT (stepped transmission), it is determined whether or not the gear position is one of any of the N (neutral) position, the P (parking) position, or the R (reverse) position. When the result of the determination is NO, the operation proceeds to step S24, and when the result of the determination is YES, the operation proceeds to step S34 and cylinder deactivation is prohibited.

In step S24, it is determined whether or not the rate of change DNE of the engine revolution rate is equal to or less than the cylinder deactivation continuing execution upper limit engine revolution change rate #EVDNEDCS, which determines whether or not to continue executing the cylinder deactivation based on the upper limit of the change in the revolution rate. When the result of the determination is NO, the operation proceeds to step S26, and when the result of the determination is YES (the case in which the rate of the decrease of the engine revolution rate is rapid), the operation proceeds to step S34 and cylinder deactivation is prohibited. This is done in order to prevent an engine stall when cylinder deactivation is carried out in the case in which the rate of decrease of the engine revolution rate is rapid.

In step S26, it is determined whether or not the battery temperature TBAT of the battery 3 is within a range equal to or greater than the cylinder deactivation lower limit battery temperature #EVTBDCSL and equal to or less than the cylinder deactivation upper limit battery temperature #EVTBDCSH. When the result of the determination is YES, the operation proceeds to step S28, and when the result of the determination is NO, the operation proceeds to step S34 and cylinder deactivation is prohibited. The reason for providing this determination is that when the temperature of the battery 3 is not within a certain range, the output of the battery 3 is unstable and cylinder deactivation should not be carried out.

In step S28, it is determined whether or not the engine revolution rate NE is within a range equal to or greater than the cylinder deactivation continuing execution lower limit engine revolution rate #EVNDCSL and equal to or less than the cylinder deactivation continuing execution upper limit engine revolution rate #EVNDCSH. When the result of the determination is YES, the operation proceeds to step S30, and when the result of the determination is NO, the operation proceeds to step S34 and cylinder deactivation is prohibited. The reason for providing this determination is that when the engine revolution rate NE is too high, there is the possibility that at the high revolution rate the oil pressure will become too high and thereby the switching to cylinder deactivation will become impossible. In addition, there is the possibility that consumption of the hydraulic fluid for cylinder deactivation will worsen. Additionally, it is necessary to recover from cylinder deactivation before the engine revolution rate NE has fallen.

In step S30, it is determined whether or not the master power negative pressure MPGA is equal to or greater than the cylinder deactivation operation continuing execution upper limit negative pressure #MPDCS, which determines whether or not to continue executing the cylinder deactivation based on the upper limit of the negative pressure. Here, the cylinder deactivation operation continuing execution upper limit negative pressure #MPDCS is a value retrieved from a table and set depending on the vehicle speed VP (a value that becomes low as the vehicle speed increases (the negative pressure becoming high)). The reason for providing this determination is that preferably the master power negative pressure MPGA is set depending on the kinetic energy of the vehicle, that is, the vehicle speed VP, while taking into consideration that the master power negative pressure is for stopping the vehicle. When the result of the determination is YES, the operation proceeds to step S32, and when the result of the determination is NO, the operation proceeds to step S34 and cylinder deactivation is prohibited. The reason for providing this determination is that continuing the cylinder deactivation when sufficient master power negative pressure MPGA cannot be obtained is not preferable.

In step S32, “1” is input into the cylinder deactivation permission flag F_KYTENB, and cylinder deactivation is identified. Then the operation for the present flowchart terminates. The determined value of this cylinder deactivation permission flag is used in the cruise EV request determination described next.

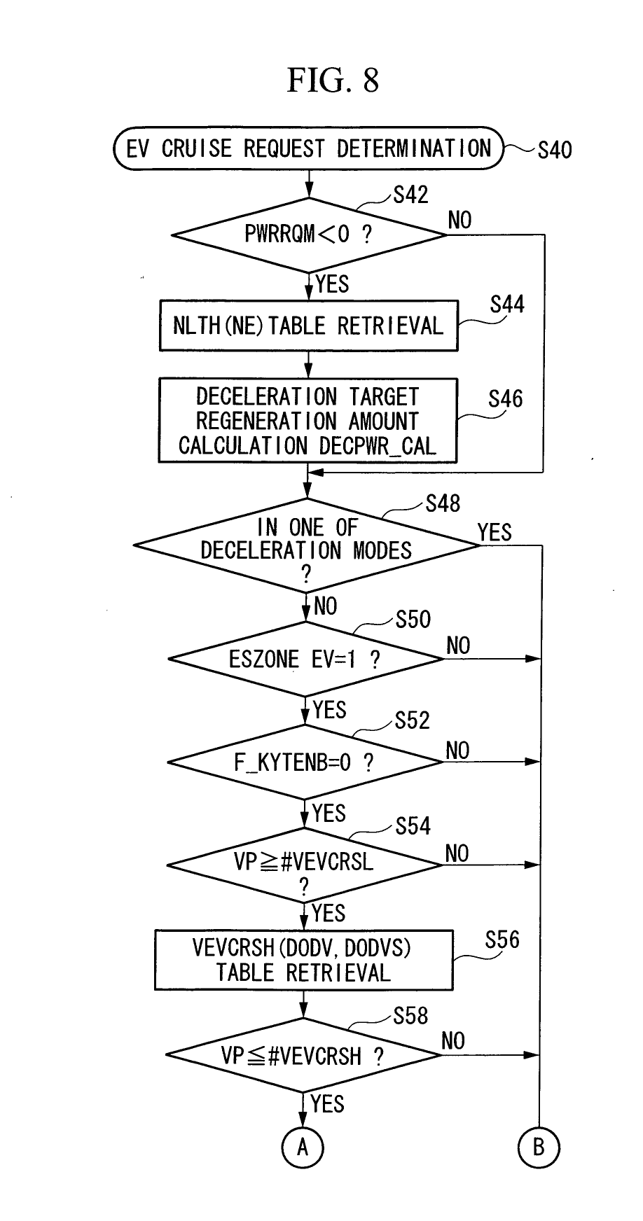

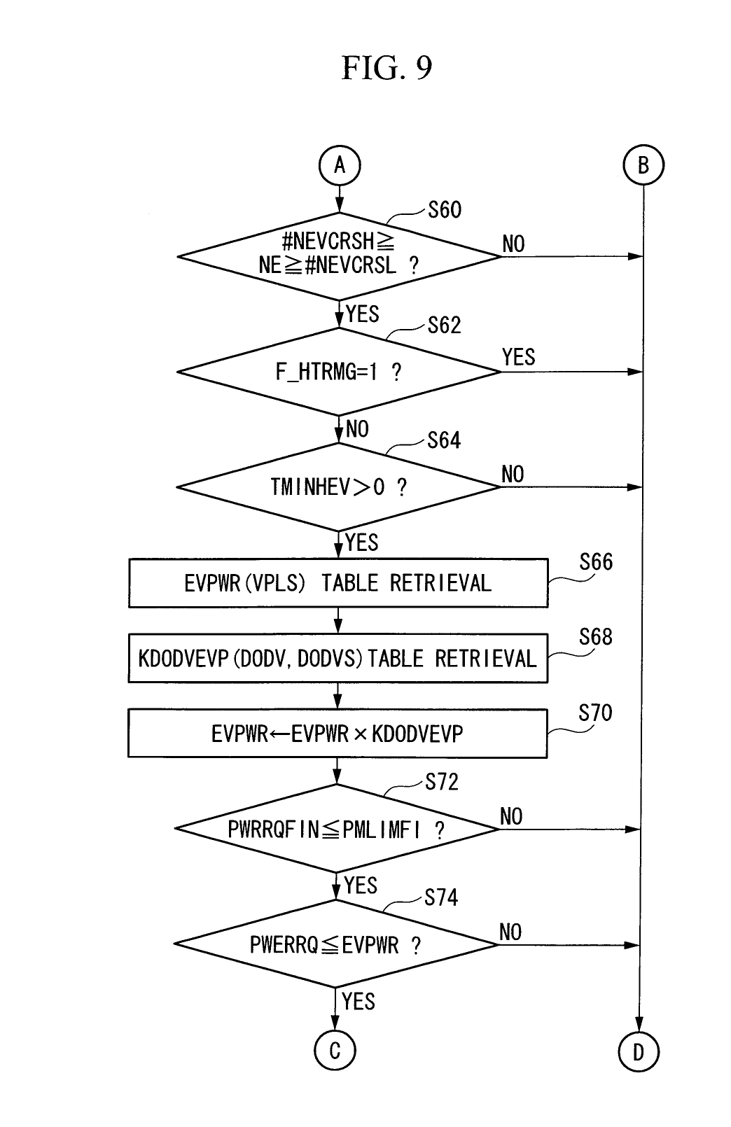

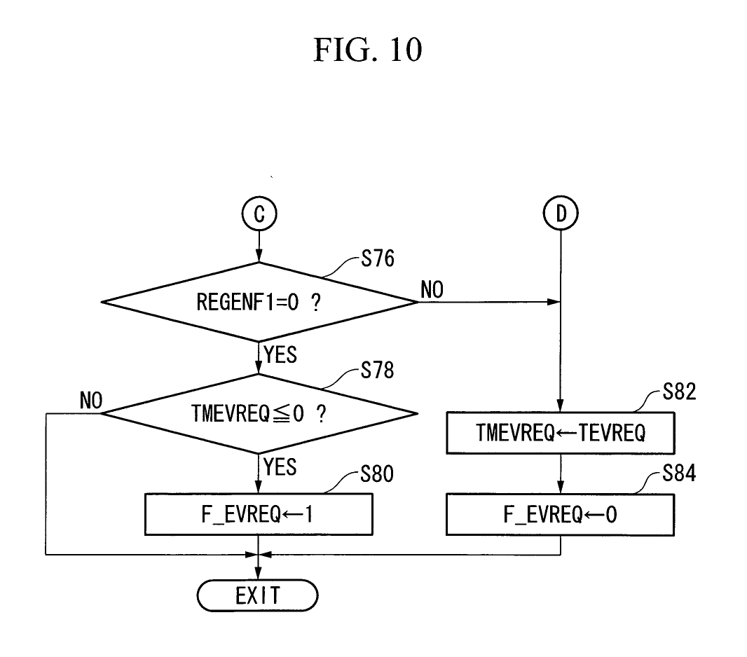

FIG. 8 to FIG. 10 are flowcharts showing the content of the operation for the EV request determination during cruise travel. First, in step S40, the operation for the cruise EV request determination is started. Next, in step S42, the requested output PWRRQM of the engine E is retrieved from a table depending on the engine revolution rate NE and the throttle opening degree THA, and it is determined whether or not this requested output PWRRQM is less than 0. When the result of the determination is YES, the operation proceeds to step S44, and when the result of the determination is NO, the operation proceeds to step S48.

In step S44, the throttle opening degree TH in a no-load state is retrieved from a table depending on the engine revolution rate NE. Then the operation proceeds to step S46, and after carrying out the calculation of the deceleration target regeneration amount DECPWR_CAL, the operation proceeds to step S48.

In step S48, it is determined whether or not the vehicle is in a deceleration mode. When the result of the determination is YES, the operation proceeds to step S82, and when the result of the determination is NO, the operation proceeds to step S50. The operation following step S82 is explained below, and here the operation for prohibiting EV travel will be explained.

In step S50, it is determined whether or not the EV travel permission flag ESZONEEV is “1” based on the state of charge SOC of the battery 3. When the result of the determination is YES, the operation proceeds to step S52, and when the result of the determination is NO, the operation proceeds to step S82. Thereby, it is possible to carry out EV travel while the state of charge SOC of the battery 3 is sufficiently ensured.

In step S52, it is determined whether or not the cylinder deactivation permission flag F_KYTENB is “1”. When the result of the determination is YES, the operation proceeds to step S54, and when the result of the determination is NO, the operation proceeds to step S82. The reason for providing this determination is that it is not preferable to carry out EV travel while cylinder deactivation is not permitted.

In step S54, it is determined whether or not the vehicle speed VP is equal to or greater than the EV cruise lower limit vehicle speed #VEVCRSL. When the result of the determination is YES, the operation proceeds to step S56 (an upper limit vehicle speed correcting device), and when the result of the determination is NO, the operation proceeds to step S82. The reason for providing this determination is that when the EV cruise travel is carried out during low speed, the kinetic energy of the vehicle during deceleration that is expected to be obtained subsequently becomes small, and this is thought to be related to the decrease in the state of charge of the battery 3.

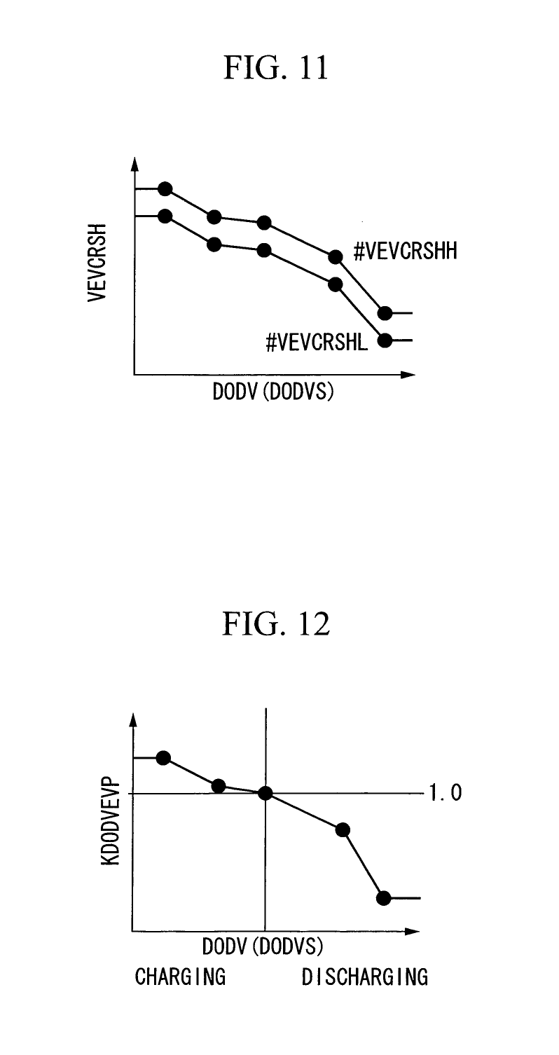

In step S56, the EV cruise execution upper limit vehicle speed #VEVCRSH (upper limit vehicle speed) is retrieved from a table based on the depth of discharge running interval limit value DODV (a difference (having either positive or negative sign) between the initial state of charge and the running interval state of charge) (refer to FIG. 11). Here, the depth of discharge running interval limit value DODV is defined as a difference between the initial state of charge that is the state of charge of the battery 3 at turning of the ignition of the vehicle (before starting travel) and the state of charge of the battery 3 obtained at each vehicle stop (running interval state of charge). In other words, it indicates how much electric energy has been consumed from (or added to) the electric energy of the battery 3 at the very start of travel. Note that the running interval state of charge is obtained based on the integrated value of electric current that is continuously measured. Here, the previous travel history may be stored, and the initial state of charge may be read out upon starting the engine, or the initial state of charge may be calculated based on the voltage after starting the engine.

FIG. 11 is a graph showing the relationship between depth of discharge running interval limit value DODV and the EV cruise execution upper limit vehicle speed #VEVCRSH. As shown in the figure, there is an approximately inverse proportional relationship between the depth of discharge running interval limit value DODV and the EV cruise execution upper limit vehicle speed #VEVCRSH. That is, when the depth of discharge running interval limit value DODV becomes high, the EV cruise execution upper limit vehicle speed #VEVCRSH becomes low, and thereby EV cruise travel becomes possible only at a lower speed. In contrast, when the depth of discharge running interval limit value DODV becomes low, the EV cruise execution upper limit vehicle speed #VEVCRSH becomes high, and thereby EV cruise travel is permitted at a higher speed.

Next, in step S58, it is determined whether or not the vehicle speed VP is equal to or less than the EV cruise execution upper limit vehicle speed #VEVCRSH. When the result of the determination is YES, the operation proceeds to step S60, and when the result of the determination is NO, the operation proceeds to step S82. Note that the EV cruise execution upper limit vehicle speed #VEVCRSH is characterized by hysteresis. The vehicle speed range is divided, by the upper limit vehicle speed as a boundary, into an EV cruise region in which a electric motor-only travel is permitted and the other region; however, an EV cruise execution upper limit vehicle speed high threshold #VEVCRSHH is used as the reference when the travel mode is getting out of the EV cruise region, and in contrast, an EV cruise execution upper limit vehicle speed low threshold #VEVCRSHL is used as the reference when the travel mode is getting into the EV cruise region from other travel modes. Thereby, a hunting phenomenon can be prevented.

In step S60, it is determined whether or not the vehicle revolution rate NE is equal to or greater than the EV cruise travel execution lower limit revolution rate #NEVCRSL and equal to or less than the EV cruise execution upper limit revolution rate #NEVCRSH. When the result of the determination is YES, the operation proceeds to step to step S62, and when the result of the determination is NO, the operation proceeds to step S82. By controlling the engine revolution rate in this manner, preventing engine stall and the like can be realized.

In step S62, it is determined whether or not the idle stop prohibition flag F_HTRMG is “1” based on the electric power required by the accessories such as the air conditioning. When the result of the determination is NO, the operation proceeds to step S64, and when the result of the determination is YES, the operation proceeds to step S82. Due to this determination, it is possible to travel while the electric power for operating the accessories is ensured, and it is possible to ensure commercial value.

In step S64, it is determined whether or not the time passed TMINTEV after the completion of the previous EV larger than 0. When the result of the determination is YES, the operation proceeds to step S66, and when the result of the determination is NO, the operation proceeds to step S82. Thereby, it is possible to prevent the travel mode from changing in short periods of time, and it is possible to ensure travel stability. Note that, although not shown in figures, the time passed TMINTEV is set after the EV cruise travel is completed.

In step S66, the cruise EV permission determination output table (EVPWR TABLE) is searched. The cruise EV permission determination output table is a table for determining whether or not the EV cruise travel is permitted, and the permission determination is retrieved based on the vehicle speed VP. Then in step S68 (an upper limit output power correcting device), the EV cruise correction coefficient KDODVEVP is retrieved from the table based on the depth of discharge running interval limit value DODV (refer to FIG. 12). Here, the EV cruise correction coefficient KDODVEVP is a coefficient that is determined depending on the value of the depth of discharge running interval limit value DODV and that is set to the EV cruise permission output power EVPWR (upper limit output power) during the EV cruise travel that is permitted in step S66.

FIG. 12 is a graph showing the relationship between the depth of discharge running interval limit value DODV and the output power correcting coefficient KDODVEVP. As shown in the figure, when the depth of discharge running interval limit value DODV reverts to the discharge cycle, the correction coefficient KDODVEVP becomes smaller than 1, and when the depth of discharge running interval limit value DODV reverts to the charge cycle, the correction coefficient KDODVEVP becomes greater than 1.

In step S70 (the upper limit output power correcting device), the value equal to the correction coefficient KDODVEVP multiplied by the cruise EV permission output power EVPWR is reset as the new cruise EV permission output power EVPWR. Thereby, it is possible to carry out more exact control that takes into account the driving status of the vehicle, and thereby it is possible to realize further improvements in fuel economy while ensuring the driving performance.

In step S72, it is determined whether or not the drive side output power limit value PWRRQFIN is equal to or less than the upper limit value PMLIMFI. This is the drive side output power limit value determined by the electric motor ECU 1. When the result of the determination is YES, the operation proceeds to step S74, and when the result of the determination is NO, the operation proceeds to step S82.

In step S74, it is determined whether or not the vehicle required output power PWERRQ is equal to or less than the EV cruise permission output power EVPWR during EV cruise travel. When the result of the determination is YES, the operation proceeds to step S76, and when the result of the determination is NO, the operation proceeds to step S82.

In step S76, it is determined whether or not REGENF1 is “0”, that is, whether or not there is a charge request. When the result of the determination is YES, the operation proceeds to step S78, and when the result of the determination is NO, the operation proceeds to step S82. This procedure is provided to prohibit the EV cruise travel when charging electric energy is required.

In step S78, it is determined whether or not the EV request timer TMEVREQ is equal to or less than 0. When the result of the determination is YES, the operation proceeds to step S80, and when the result of the determination is NO, the operation for this flowchart terminates. Note that the EV request timer TMEVREQ is set in step S82 to be described below.

In step S80, “1” is input into the flag F_EVREQ. Thereby, EV cruise travel is permitted. Next, the operation for this flowchart terminates.

In contrast, in step S82, the predetermined request time TEVREQ is input into the EV request timer TMEVREQ. Then in step S84, “0” is input into the flag F_EVREQ. Thereby, EV cruise travel is prohibited.

Here, in the above embodiment, the EV cruise execution upper limit vehicle speed #VEVCRSH that is the upper limit vehicle speed is corrected based on the depth of discharge running interval limit value DODV in steps S56 and S58 and as shown in FIG. 11, and the EV cruise permission output power EVPWR that is the upper limit output power is corrected based on the depth of discharge running interval limit value DODV in steps S68 and S70 and as shown in FIG. 12; however, in addition to this or alternatively, the EV cruise execution upper limit vehicle speed #VEVCRSH that is the upper limit vehicle speed and the EV cruise permission output power EVPWR that is the upper limit output power may be corrected by taking into account an interval state of charge difference DODVS (an amount of change) that is another factor, as described below.

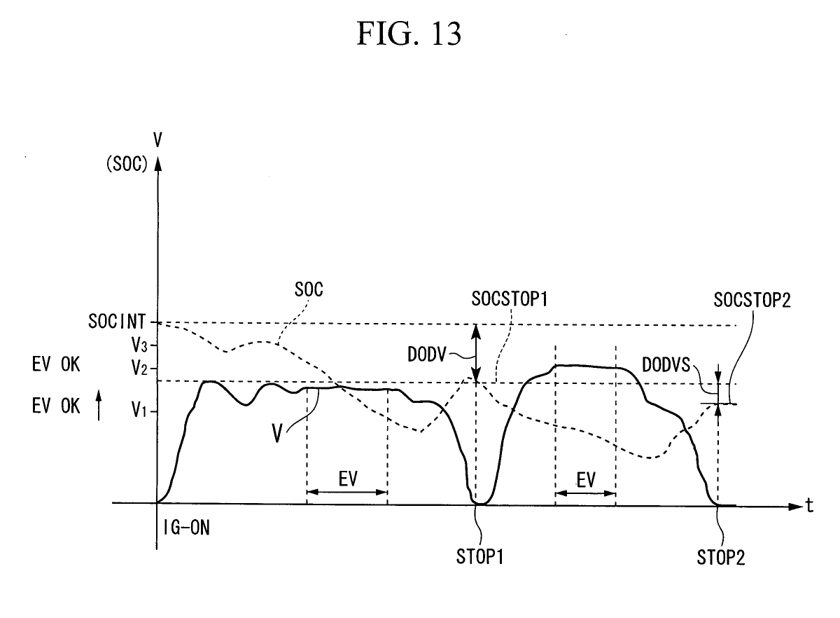

FIG. 13 shows changes in the state of charge and the vehicle speed of a traveling vehicle where the horizontal axis represents time t and the vertical axis represents the state of charge SOC of the battery 3 (and the vehicle speed V). The vehicle starts traveling after reading in the initial state of charge SOCINT upon turning on the ignition (IG-ON), and stops at time STOP1 after completion of the EV cruise travel. If the state of charge at this moment is defined as a state of charge SOCSTOP1 (a running interval state of charge), the following equation is satisfied.

Depth of discharge running interval limit value DODV=Initial state of charge SOCINT−State of charge SOCSTOP1

The electric motor-only travel has been executed within a range from the EV cruise lower limit vehicle speed #VEVCRSL (V₁) to the EV cruise upper limit vehicle speed #VEVCRSH (V₂) based on the depth of discharge running interval limit value DODV, and the next travel is started after correcting the EV cruise upper limit vehicle speed #VEVCRSH (made higher to V₃) as well as the EV cruise permission output power EVPWR by the amounts corresponding to the recovery of the state of charge of the battery 3 that is caused by the increase in the state of charge of the battery 3 due to a regenerative operation during deceleration travel until the vehicle stops at time STOP1.

If the vehicle resumes travel, performs EV travel at a vehicle speed slightly higher than that in the previous travel, stops at time STOP2, and the state of charge at this moment is defined as SOCSTOP2 (running interval state of charge), the state of charge SOC of the battery 3 at time STOP2 is decreased from that at time STOP1 by the amount of the interval state of charge difference DODVS.

Accordingly, the EV cruise upper limit vehicle speed #VEVCRSH or the EV cruise permission output power EVPWR can be corrected with reference to the interval state of charge difference DODVS, or the interval state of charge difference DODVS can be taken into account when the EV cruise upper limit vehicle speed #VEVCRSH or the EV cruise permission output power EVPWR is corrected based on the depth of discharge running interval limit value DODV. As explained above, by using the interval state of charge difference DODVS, it is possible to execute a more precise and responsive control due to consideration of the amount of decrease in the interval, and it is possible to further improve the fuel economy by restraining the EV cruise upper limit vehicle speed #VEVCRSH or the EV cruise permission output power EVPWR while maintaining the driving performance.

Because the control operation using the interval state of charge difference DODVS can be carried out as in the above embodiment by using the interval state of charge difference DODVS with the depth of discharge running interval limit value DODV or instead of the depth of discharge running interval limit value DODV in steps S56 and S68 in FIG. 8, and in FIGS. 11 and 12, the description thereof is omitted by combining the characters of “DODVS” in parentheses with “DODV”.

Note that the present invention is not limited by the embodiment described above. For example, in the embodiment, the case of a CVT (continuously variable transmission) was explained, but the invention is not limited thereby, and can also be applied to an AT (step-geared transmission). In this case, a lock-up clutch may also be used. In addition, the upper limit vehicle speed or the upper limit output power may be corrected based on the rate of change (amount of change per unit time) of the depth of discharge of the high voltage battery 3.

Furthermore, the case in which all cylinders are deactivated was explained as an example; however, the present invention can also be applied to a vehicle having an engine of a partial cylinder deactivation type in which some of the cylinders are deactivated. In this case, during the EV cruise travel described above, the operations of the intake and exhaust valves are continued in non-deactivated cylinders; however, fuel is not supplied to those cylinders; therefore, the engine does not produce driving power.

### INDUSTRIAL APPLICABILITY

The control apparatus for a hybrid vehicle of the invention can be applied to a vehicle including an engine and an electric motor and being capable of traveling solely by the driving power of the electric motor or the driving power of the engine, and fuel economy can be improved while ensuring the driving performance.

1. A control apparatus for a hybrid vehicle that comprises an engine and an electric motor as driving sources for the vehicle, and an energy storage device that stores an output of the engine or a kinetic energy of the vehicle after being converted into electric energy by the electric motor, the engine being a cylinder deactivation engine that is capable of deactivating, the control apparatus comprising:
an electric motor-only travel determination device that determines whether a motor-only travel, in which the engine is deactivated and only the motor is used for driving the vehicle, is allowed based on at least vehicle speed;
an initial state of charge calculating device that calculates an initial state of charge of the energy storage device when an ignition of the vehicle is turned on;
a running interval state of charge calculating device that calculates an amount of change between a state of charge of the energy storage device at each time the vehicle stops; and
an upper limit vehicle speed correcting device that corrects an upper limit vehicle speed during an electric motor-only travel that is allowed by the electric motor-only travel determination device based on a difference between the initial state of charge calculated by the initial state of charge calculating device and the running interval state of charge calculated by the running interval state of charge calculating device.

2. The control apparatus for a hybrid vehicle according to claim 1, further comprising an upper limit output correcting device that corrects an upper limit output power during the electric motor-only travel that is allowed by the electric motor-only travel determination device based on the difference between the initial state of charge calculated by the initial state of charge calculating device and the running interval state of charge calculated by the running interval state of charge calculating device.

3. The control apparatus for a hybrid vehicle according to claim 1, further comprising:
an interval state of charge difference calculating device that calculates an amount of change from the state of charge of the energy storage device at a previous vehicle stop to the state of charge of the energy storage device at a present vehicle stop; and
an upper limit vehicle speed correcting device that corrects an upper limit vehicle speed during an electric motor-only travel that is allowed by the electric motor-only travel determination device based on the amount of change in the state of charge calculated by the interval state of charge difference calculating device.

4. The control apparatus for a hybrid vehicle according to claim 1, further comprising an upper limit output power correcting device that corrects an upper limit output power during an electric motor-only travel that is allowed by the electric motor-only travel determination device based on the amount of change in the state of charge calculated by the interval state of charge difference calculating device.

5. A control apparatus for a hybrid vehicle that comprises an engine and an electric motor as driving sources for the vehicle, and an energy storage device that stores an output of the engine or a kinetic energy of the vehicle after being converted into electric energy by the electric motor, the engine being a cylinder deactivation engine that is capable of deactivating, the control apparatus comprising:
an electric motor-only travel determination device that determines whether a motor-only travel, in which the engine is deactivated and only the motor is used for driving the vehicle, is allowed based on at least vehicle speed;
an interval state of charge difference calculating device that calculates an amount of change from the state of charge of the energy storage device at a previous vehicle stop to the state of charge of the energy storage device at a present vehicle stop; and
an upper limit vehicle speed correcting device that corrects an upper limit vehicle speed during an electric motor-only travel that is allowed by the electric motor-only travel determination device based on the amount of change in the state of charge calculated by the interval state of charge difference calculating device.

6. The control apparatus for a hybrid vehicle according to claim 5, further comprising an upper limit output power correcting device that corrects an upper limit output power during an electric motor-only travel that is allowed by the electric motor-only travel determination device based on the amount of change in the state of charge calculated by the interval state of charge difference calculating device.
